(19) United States
(12) Patent Application Publication
(10) Pub. No.: US 2024/0164393 A1
(43) Pub. Date: May 23, 2024

(54) Bucket Barbecue Smoker

(71) Applicant: Michael Freer, Humboldt, TN (US)

(72) Inventor: Michael Freer, Humboldt, TN (US)

(21) Appl. No.: 17/993,295

(22) Filed: Nov. 23, 2022

(51) Int. Cl. A23B 4/052

(52) U.S. Cl. CPC A23B 4/052

(57) ABSTRACT

A smoker apparatus that includes a container with an open end, a removable lid for covering the open end of the container, a basket positionable inside the container for holding a combustible smoking material, a heat reflector positionable above the basket inside the container, a pan positionable above the heat reflector inside the container, and a grate positionable above the pan.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

The present invention generally relates to a cooking apparatus and, more particularly, to a barbecue smoker.

Smoking meats on a barbecue smoker can be time-consuming and difficult to manage. Barbecue smokers are generally large, hard to move, and take up a lot of space. When using a smoker, it takes a rather long time for the meat to cook and refilling the charcoal is required every couple of hours to maintain a steady heat. It would therefore be desirable to develop a barbecue smoker that is compact, portable, holds enough charcoal to last 10+ hours without refilling, and can be converted to a portable grill to cook other food products such, as steak, vegetables, etc.

### BRIEF SUMMARY OF THE INVENTION

The present invention is directed to a bucket barbecue smoker for cooking meat that includes (a) a container; (b) a lid connected to the container that covers the interior of the container; (c) a basket positioned in the interior of the container; (d) a heat reflector positioned above the basket; (e) a pan positioned above the heat reflector; and (f) a grate on which the meat is placed that is positioned over the pan.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a perspective view of the smoker.

FIG. 2 is an exploded view of the smoker.

FIG. 3 is a partial cut-away view of the smoker.

FIG. 4 is a partial see-through view and a partial cut-away view of the smoker.

FIG. 5 is a perspective view of the heat reflector, pan, and grate of the smoker.

FIG. 6 is a perspective view of the basket of the smoker.

FIG. 7 is a perspective view of the smoker.

FIG. 8 is a perspective view of the smoker with an alternative lid.

### DETAILED DESCRIPTION OF THE INVENTION

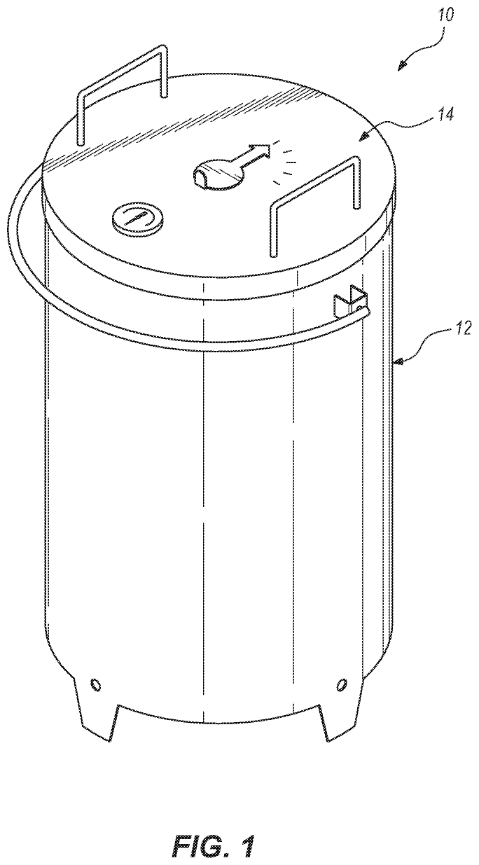

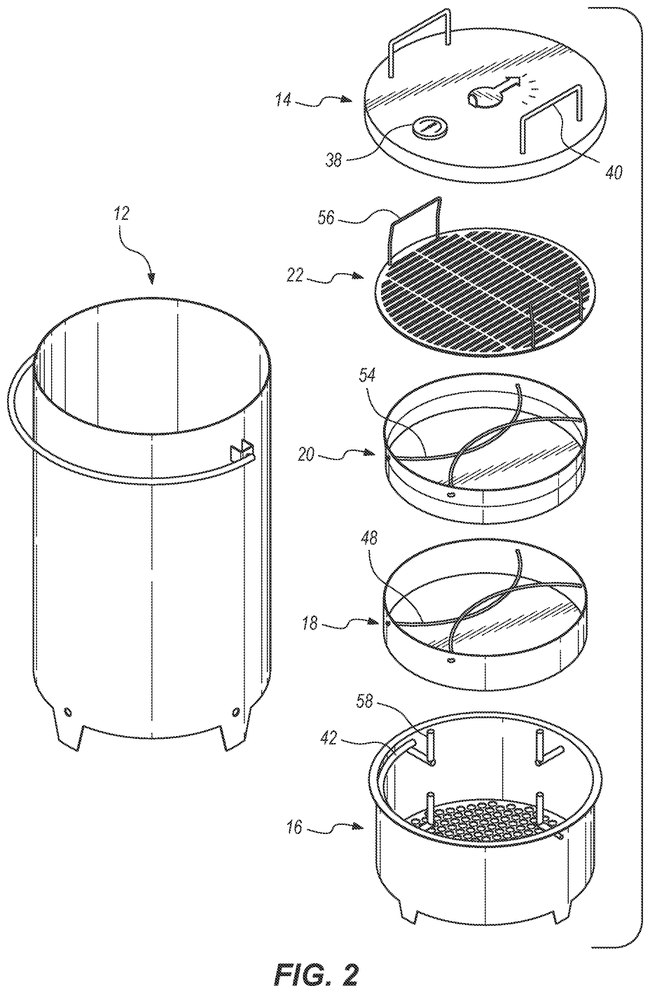

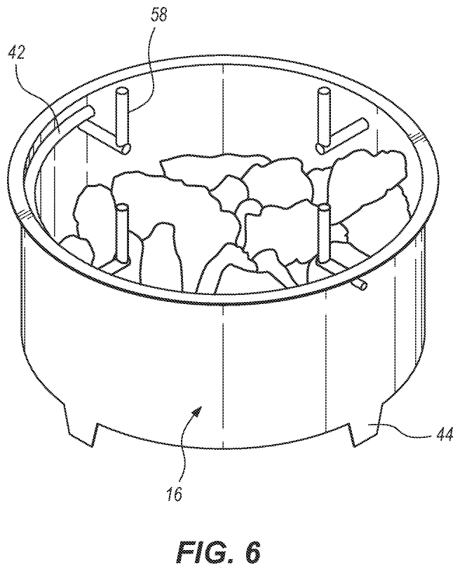

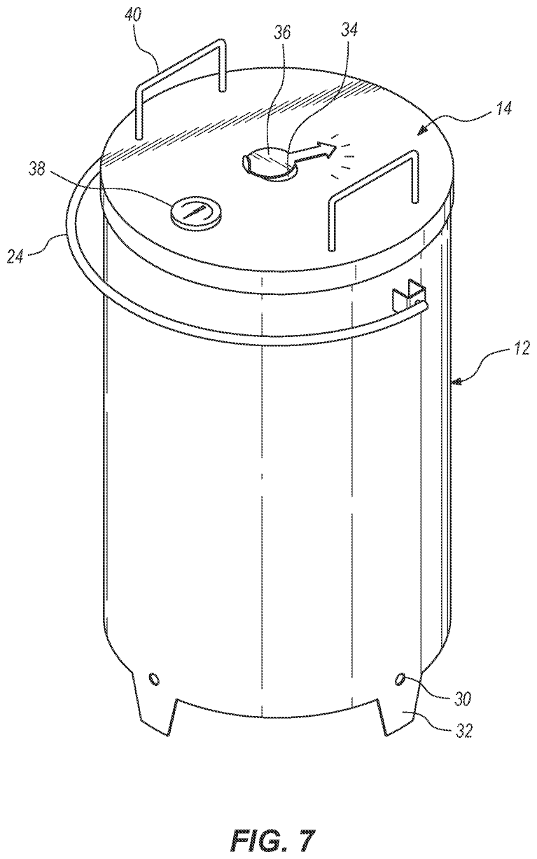

With references to FIGS. 1-8, the preferred embodiments of the present invention may be described. The present invention is directed to a bucket barbecue smoker 10. The smoker 10 of the present invention includes the following parts: a container 12, a lid 14, a basket 16, a heat reflector 18, a pan 20, and a grate 22, as shown in FIGS. 1-8.

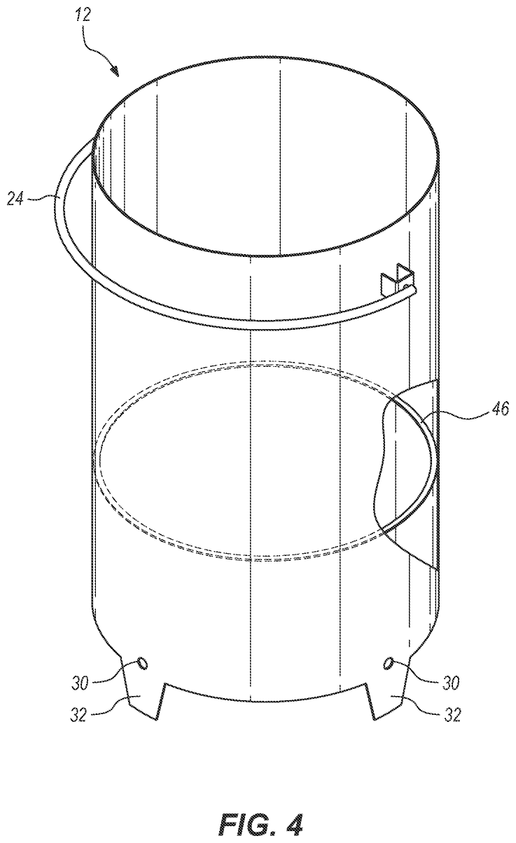

The container 12 preferably is a cylindrical shape open container. In alternative embodiments, the container 12 may have a cross-sectional shape that is oval, square, or rectangular, or another suitable shape that would be well-known to a person of ordinary skill in the art. The container 12 has a handle 24 for grasping by hand for moving the smoker 10. A ring 46 is positioned on the inner surface of the container 12 and extends into the open interior of the container 12, as shown in FIG. 4. The width of the ring 46 is preferably ⅜″ wide in one embodiment. The diameter of the container 12 is preferably 14 inches in one embodiment. The height of the container 12 is preferably 24-25 inches in one embodiment. The container 12 preferably has vent holes 30 that are spaced apart from one another near the bottom of the container 12 to allow for air transfer into the container 12. In one embodiment, there are four vent holes 30. The container 12 preferably has four legs 32 that extend from the bottom of the container 12 on which the smoker 10 stands. The container 12 is preferably made of stainless steel or any suitable heat resistant material.

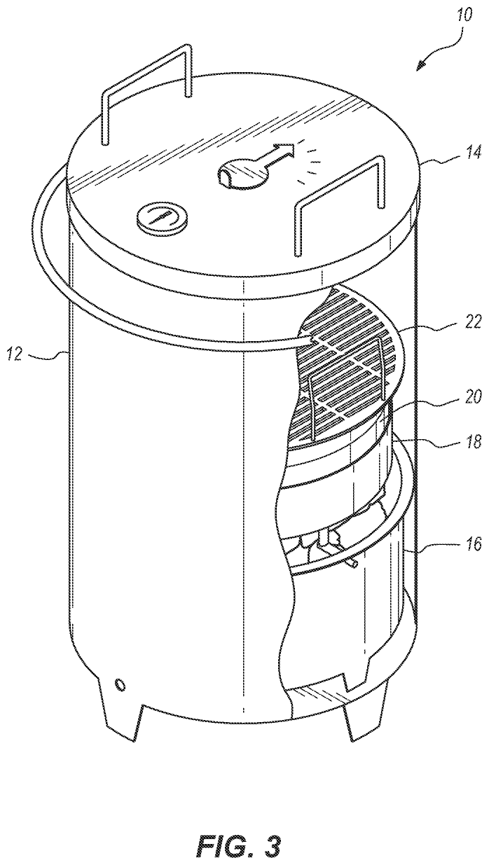

A lid 14 is sized to cover the open end of the container 12. The lid 14 preferably rests on the top surface of the container 12, as shown in FIGS. 1 and 3. The lid 14 is preferably a removable cylindrical-shaped cover. A thermometer 38 extends through the lid 14 to monitor the temperature inside the container 12. In one embodiment, the thermometer 38 is a cooking thermometer that shows the temperature inside the container 12 and has a guide with different colors correlating to the type of cooking being done. Alternatively, the thermometer may be any suitable cooking thermometer that would have been well-known to a person of ordinary skill in the art. In an alternative embodiment, the thermometer 38 is installed on the side of the container 12 instead. The lid 14 preferably has two handles 40 for grasping by hand to lift the lid off of the container 12. The diameter of the lid 14 is preferably greater than the diameter of the container 12. The lid 14 is preferably made of stainless steel or any other heat resistant material.

In one embodiment, the lid 14 has a vent 34 in its top surface. A cover 36 covers the vent 34 to make the size of opening adjustable to reach the target temperature desired inside the container 12. The lid 14 has numerals or markings to show how far the cover 36 is adjusted as a reference or a guide for future uses.

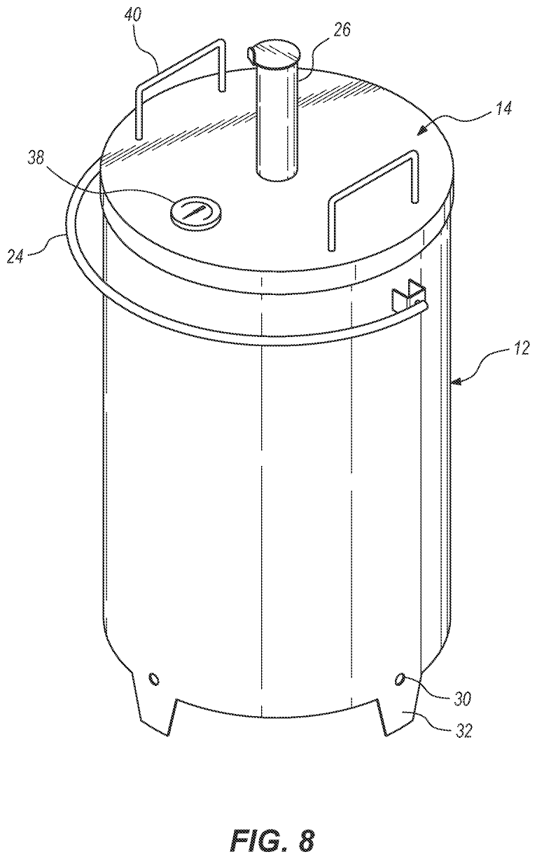

In another embodiment, the lid 14 has a smoke stack pipe 26 in its top surface, as shown in FIG. 8. The smoke stack pipe 26 is a tube to assist with air flow through the smoker 10. The diameter of the smoke stack pipe 26 is preferably 1.5 inches in one embodiment. The height of the smoke stack pipe 26 is preferably 4 inches in one embodiment. A cover (such as cover 36 on the lid 14) covers the smoke stack pipe 26 to make the size of opening adjustable to reach the target temperature desired inside the container 12. The smoke stack pipe 26 preferably is made of stainless steel or any other heat resistant material.

The smoker 10 also includes a basket 16. The basket 16 preferably is cylindrical-shaped with an open top. During use, the basket 16 is filled with charcoal or any suitable combustible smoking material (e.g., wood chips, wood chunks, and pellets). The bottom of the basket 16 sits on the bottom of the container 12 and the top of the basket 16 rests on the ring 46 inside the container 12. The position of the ring 46 is dependent on the height of the basket 16. The ring 46 helps to seal the lip of the basket 16 to restrict any unintended air flow. The lit material delivers heat inside the container 12 to cook the meat. The bottom surface of the basket 16 is perforated for airflow. The top of the basket 16 has four L-shaped hooks 58 protruding upwards. The basket 16 has a handle 42 for the user to grasp by hand for insertion and removal of the basket 16. The basket 16 has three legs 44 extending from the bottom of the basket 16 on which the basket 16 stands. The basket 16 preferably is made of stainless steel or any other heat resistant material.

The smoker 10 also includes a heat reflector 18. The heat reflector 18 rests on top of the hooks 58 of the basket 16 that is positioned inside the container 12. The heat reflector 18 is preferably a shallow, cylindrical-shaped open container. The heat reflector 18 has handles 48 for the user to grasp for insertion and removal of the heat reflector 18. The heat reflector 18 preferably is made of stainless steel or any other heat resistant material. The heat reflector 18 keeps the intense heat from reaching the meat, as explained in more detail below.

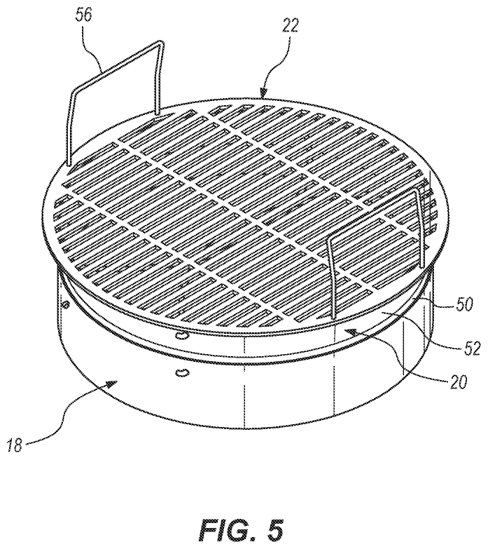

The smoker 10 also includes a pan 20. The pan 20 rests on top of the heat reflector 18 inside the container 12. The pan 20 is preferably a shallow, cylindrical-shaped open container to contain any water or drips of meat or fat. The user may add water to the pan in order to control the moisture content inside the smoker. The diameter of the bottom portion 50 of the pan 20 is smaller than the diameter of the top portion 52 of the pan 20, as shown in FIG. 5. When positioned accordingly, there is a gap of about 1 inch between the heat reflector 18 and the pan 20 to serve as an insulator to reduce the intensity of the heat on the meat. The pan 20 preferably has handles 54 for the user to grasp for insertion and removal of the pan 20. The pan 20 preferably is made of stainless steel or any other heat resistant material.

The smoker 10 also includes a grate 22. The grate 22 rests on top of the pan 20 inside the container 12. The grate 22 is a spherical shape disk with openings between intersecting bars. When in use, the meat is placed on top of the grate 22. The grate 22 preferably has handles 56 for the user to grasp for insertion and removal of the grate 22. In an alternative embodiment, the grate 22 may be positioned on top of the container 12 when the smoker 10 is being used as a traditional grill. The grate 22 preferably is made of stainless steel or any other heat resistant material.

While the components are described herein as being stackable inside the container 12, it should be understood that the components may be supported in the container 12 in other ways that would be understood by a person skilled in the art.

The present invention has been described with reference to certain preferred and alternative embodiments that are intended to be exemplary only and not limiting to the full scope of the present invention as set forth in the appended claims.

We claim:

1. A smoker apparatus comprising:
a container having an open end;
a removable lid for covering said open end of said container;
a basket positionable inside said container for holding a combustible smoking material;
a heat reflector positionable above said basket inside said container;
a pan positionable above said heat reflector inside said container; and
a grate.

2. The smoker apparatus of claim 1, further comprising a ring inside said container, wherein a top of said basket rests on said ring.

3. The smoker apparatus of claim 1, wherein said grate rests on a top of said pan inside said container.

4. The smoker apparatus of claim 1, wherein said grate is positioned on top of said container.

5. The smoker apparatus of claim 1, wherein said basket is perforated.

6. The smoker apparatus of claim 1, wherein said basket comprises a plurality of legs.

7. The smoker apparatus of claim 1, wherein said basket has hooks on which said heat reflector rests.

8. The smoker apparatus of claim 1, wherein said container comprises vent holes.

9. The smoker apparatus of claim 1, wherein said container comprises a plurality of legs.

10. The smoker apparatus of claim 1, wherein said container, said removable lid, said basket, said heat reflector, said pan, and said grate are each made of a heat resistant material.

11. The smoker apparatus of claim 1, wherein each of said container, said removable lid, said basket, said heat reflector, said pan, and said grate comprises a handle.

12. The smoker apparatus of claim 1, further comprising a thermometer.

13. The smoker apparatus of claim 1, wherein said lid comprises a vent and an adjustable cover for covering said vent.

14. The smoker apparatus of claim 13, further comprising a smoke stack pipe attached to said removable lid.

15. A smoker apparatus comprising:
a container having an open end;
a removable lid for covering said open end of said container;
a basket positionable inside said container for holding a combustible smoking material;
a heat reflector positionable above said basket inside said container;
a pan positionable above said heat reflector inside said container;
a grate; and
a smoke stack pipe extending upwards from a top surface of said removable lid.

16. The smoker apparatus of claim 15, wherein said smoke stack pipe comprises an adjustable cover.

17. The smoker apparatus of claim 15, wherein said container, said removable lid, said basket, said heat reflector, said pan, said grate, and said smoke stack pipe are each made of a heat resistant material.
